(19) United States
(12) Patent Application Publication
(10) Pub. No.: US 2004/0184395 A1
(43) Pub. Date: Sep. 23, 2004

(54) Information storage medium and method of recording and/or reproducing data thereon

(75) Inventors: Kyung-geun Lee, Gyeonggi-do (KR); Jung-wan Ko, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/798,271

(22) Filed: Mar. 12, 2004

Related U.S. Application Data
(60) Provisional application No. 60/454,618, filed on Mar. 17, 2003.

(30) Foreign Application Priority Data
Mar. 17, 2003 (KR) 2003-16496

(51) Int. Cl. G11B 7/24

(52) U.S. Cl. 369/275.3

(57) ABSTRACT

An information storage medium in which a revision number has been recorded, and a method of recording and/or reproducing data thereon. In the information storage medium, a standard version number and a revision number distinguished from the standard version number are recorded in a reproduction-only area. According to the method, data is recorded and/or reproduced in the information storage medium which includes a lead-in area, a user data area, and a lead-out area. In the method, first, a standard version number is recorded in the reproduction-only area of at least one of the lead-in and lead-out areas. Next, a revision number distinguished from the standard version number is recorded in the reproduction-only area. Thereafter, the standard version number and the revision number are read and records and/or reproduces data according to a standard associated with the standard version number and the revision number.

### CROSS REFERENCE TO RELATED APPLICATIONS

This application claims the priority of Korean Patent Application No. 2003-16496, filed on Mar. 17, 2003, in the Korean Intellectual Property Office, and the benefit of U.S. Provisional Patent Application No. 60/454,618, filed on Mar. 17, 2003, the disclosures of which are incorporated herein in their entirety by reference.

### BACKGROUND OF THE INVENTION

1. Field of the Invention

The present invention relates to an information storage medium and a method of recording and/or reproducing data thereon, and more particularly, to an information storage medium on which a revision number associated with additional information is recorded if the additional information is generated according to a standard with a certain same version number, and a method of recording and/or reproducing data on the information storage medium.

2. Description of the Related Art

General information storage media are widely used as information recording media of optical pickup apparatuses for recording/reproducing information in a non-contact way. Optical disks, which are information storage media, are classified as compact disks (CDs) or digital versatile disks (DVDs) according to their information storage capacity. Examples of recordable optical disks are 650 MB CD-R, CD-RW, and 4.7 GB DVD+RW. Furthermore, HD-DVDs having a recording capacity of 20 GB or greater are under development.

Standards for the physical structures of various types of storage media or for various methods of recording and/or reproducing data thereon are being established. The standards for storage media deal with a great number of factors, particularly, recording capacity and recording speed. For example, if many recording/reproduction conditions are required to increase the recording capacity and they are different from the conditions prescribed in an existing standard, standard version numbers vary with the upgrading standards.

When a standard version number is updated, recording/reproduction conditions are prescribed according to a new standard. Contents related to recording/reproduction keep changing, and additional information about the changed contents needs to be provided. In general, when a new standard is determined, the version number is changed. However, only some of the contents related to recording/reproduction may be changed without any change in the version number. In the related art, such additional information is not recorded in storage media, and instead, it is provided through an extra additional information file.

In storage media having a standard version 2.0, 1× to 4× recording speeds are generally prescribed. However, such storage media can record data at up to 5× recording speed. Here, because all of the existing recording speeds are satisfied, the version number is not changed, and information about a 5× recording speed must be additionally provided. In the case of the storage media with a standard version 2.0, information indicating that they can record data at 5× speed is recorded in an extra additional information file.

Accordingly, when additional information is generated, a drive system cannot recognize the additional information, thus causing great inconvenience to users.

### BRIEF SUMMARY

The present invention provides an information storage medium in which a revision number about additional information associated with standards having an identical version number is recorded as reproduction-only data, and data can be adaptively recorded and/or reproduced depending on the revision number.

According to an aspect of the present invention, there is provided an information storage medium comprising a reproduction-only area in which a standard version number and a revision number different from the standard version number are recorded.

The information storage medium may include a lead-in area, a user data area, and a lead-out area, and the reproduction-only area may be included in at least one of the lead-in and lead-out areas.

The reproduction-only area may be a disk control data zone, and the revision number may be recorded in an m-th byte of the disk control data zone.

When the revision number is x.y, x may be recorded in the first four bits of the m-th byte, and y may be recorded in the last four bits of the m-th byte.

According to another aspect of the present invention, there is provided a method of recording and/or reproducing data in an information storage medium which includes a lead-in area, a user data area, and a lead-out area, the method including: recording a standard version number in the reproduction-only area of at least one of the lead-in and lead-out areas, recording a revision number distinguished from the standard version number in the reproduction-only area, and reading the standard version number and the revision number and recording and/or reproducing the data according to a standard associated with the standard version number and the revision number. The last operation is performed by a drive.

According to still another aspect of the present invention, there is provided a drive system for recording and/or reproducing data on an information storage medium having a reproduction-only area in which a standard version number and a revision number different from the standard version number are recorded. The drive system includes a pickup which records and/or reproduces the data from the information storage medium. When the information storage medium is inserted into the drive system, the drive system reads out the version number and the revision number and records and/or reproduces the data according to a standard corresponding to the version number and the revision number.

According to still another aspect of the present invention, there is provided a drive system for recording data on an information storage medium, including: an audio/video (AV) encoder which compresses an AV signal according to a specified compression scheme and outputs compressed AV data; a digital signal processor which receives the compressed AV data, adds data for electronic code correction (ECC) processing to the compressed AV data, modulates the resulting data according to a specified modulation scheme, and outputs modulated data; a radio frequency (RF) amplifier which converts the modulated data into an RF signal and outputs the RF signal; and a pickup which records the RF signal on the information storage medium. The data includes a standard version number and a revision number different from the standard version number.

According to still another aspect of the present invention, there is provided a drive system for reproducing data recorded on an information storage medium, including; a pickup which detects an optical signal from the information storage medium; a radio frequency (RF) amplifier which converts the optical signal into an RF signal of modulated data and outputs the RF signal; a digital signal processor which demodulates the modulated data according to a modulation scheme, performs error correction code (ECC) processing, and outputs compressed audio/video (AV); and an AV decoder which decodes the compressed AV data and outputs an AV signal. The data is a standard version number and a revision number different from the standard version number.

Additional and/or other aspects and advantages of the present invention will be set forth in part in the description which follows and, in part, will be obvious from the description, or may be learned by practice of the invention.

### BRIEF DESCRIPTION OF THE DRAWINGS

These and/or other aspects and advantages of the present invention will become apparent and more readily appreciated from the following detailed description, taken in conjunction with the accompanying drawings of which:

FIG. 1 shows the structure of a data area in a recordable information storage medium;

FIG. 2 shows the data structure of a disk control data zone in a lead-in area included in an information storage medium according to an embodiment of the present invention;

FIG. 3 is a diagram for explaining a method of recording and/or reproducing data on an information storage medium according to an embodiment of the present invention;

FIG. 4 shows the structure of a data area in a conventional reproduction-only information storage medium; and

FIG. 5 is a block diagram of a drive device for recording and/or reproducing data on an information storage medium according to an embodiment of the present invention.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

An information storage medium according to an embodiment of the present invention and a method of recording and/or reproducing data thereon will now be described.

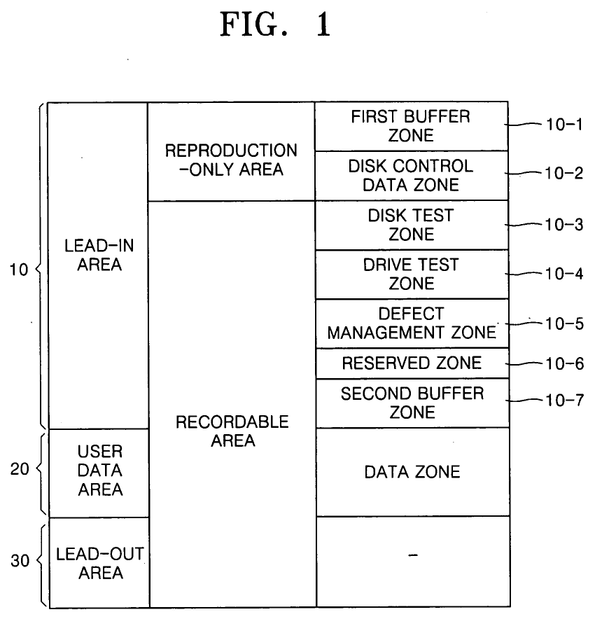

FIG. 1 shows the structure of a data area in a recordable information storage medium, which includes a lead-in area 10, a user data area 20, and a lead-out area 30. A standard version number and a revision number are recordable in a reproduction-only area of at least one of the lead-in and lead-out areas 10 and 30.

If a recording/reproduction characteristic of a storage medium has been changed and its standard version number has been changed, a number associated with information about the changed characteristic is provided and referred to as a revision number. The revision number is providable when additional information is generated.

In other words, when the content of at least one of the items associated with data recording and/or reproduction, which are set according to a standard corresponding to the standard version number, has been changed, a revision number corresponding to the changed item is recorded.

The lead-in area 10 is divisible into a reproduction-only area and a recordable area. The lead-in area 10 includes a first buffer zone 10-1, a disk control data zone 10-2, a disk test zone 10-3, a drive device test zone 10-4, a defect management zone 10-5, a reserve zone 10-6, and a second buffer zone 10-7. For example, the first buffer zone 10-1 and the disk control data zone 10-2 belong to the reproduction-only area, where data is recorded during the manufacture of a storage medium. The other zones belong to the recordable area.

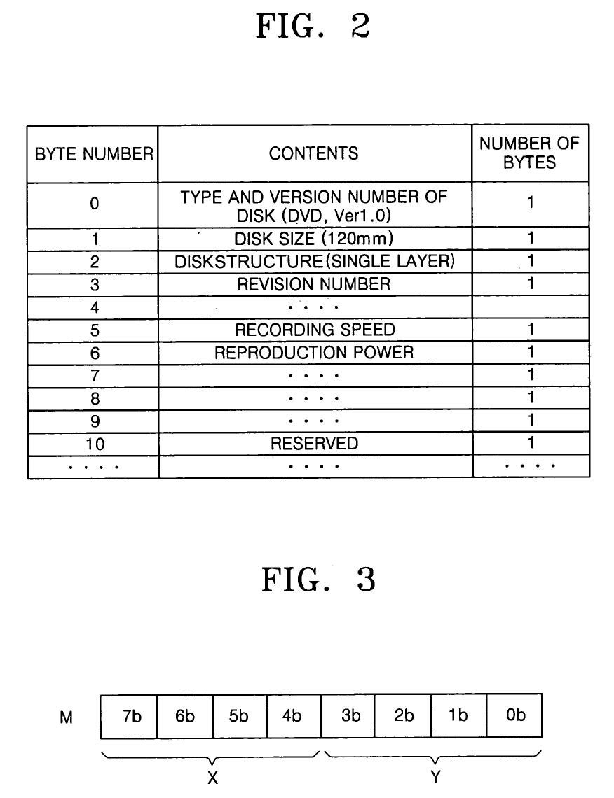

A version number and a revision number are recorded in the disk control data zone 10-2. As shown in FIG. 2, the disk control data zone 10-2 is comprised of a plurality of bytes. The revision number is recordable in an m-th byte of the disk control data zone 10-2. FIG. 2 shows an example in which a revision number is recorded in a third byte of the disk control data zone 10-2. Alternatively, the revision number is recordable in a reserve zone, which is a tenth zone.

As shown in FIG. 3, one byte is comprised of 8 bits, which are zeroth through seventh bits (0b through 7b). If the revision number is x.y, and it is recorded in one byte, x is recorded in the four bits in the front, that is, seventh through fourth bits 7b through 4b, while y is recorded in the four bits in the back, that is, the third through zeroth bits 3b through 0b. If the revision number is 0.1, it is recordable as 00000001b. If the revision number is 1.1, it is recordable as 00010001b. When the revision number is recorded in this manner, a hexadecimal or binary system are usable.

An example of a storage medium in which a standard version is unchanged and a revision number is provided to the storage medium will now be described. For example, the standard version 2.1 prescribes 1× to 4× recording speeds. However, if up to 5× recording speed is possible, the fact that data is also recordable at a 5× recording speed without change in the version number 2.1 needs to be represented. In this case, the version number, for example, 2.1, is recordable in a zeroth byte, while a revision number, for example, 1.0, is recordable in an m-th byte. A drive device, which records/reproduces data on/from a storage medium, reads out the revision number and accordingly can record/reproduce data at a 5× recording sped.

If data is recordable not only at 1× to 4× recording speeds but also at 5× and 6× recording speeds, the version number is maintained as 2.1, and a revision number is recorded, representing additional information about the 6× recording speed. For example, 2.0 is recordable as the new revision number. The drive device reads out the new revision number and accordingly can record and/or reproduce data at the 6× recording speed. If the revision number is 1.0, data is recordable at up to 5× recording speed. If the revision number is 2.0, up to 6× recording speed is possible to record data.

In the above, the provision of a revision number when a recording speed is changed has been described. However, even when an element other than the recording speed is changed, for example, even when a mass eccentricity or a recording capacity is changed, a revision number is provided.

As described above, the revision number is updatable every time new additional information is generated. The updated revision number is recorded in a specified single byte. The revision number is recorded as reproduction-only data upon the manufacture of a storage medium. For example, the revision number is recordable in the form of pits or a groove wobble.

Also, the revision number is recordable in both the reproduction-only area of the lead-in area 10 and that of the lead-out area 30. Alternatively, the revision number is recordable in each of at least two bytes of the reproduction-only area of the lead-in or lead-out area 10 or 30. For example, a revision number is recordable in each of m-th and (m+1)th bytes of the disk control data zone 10-2. By doing this, when any of the repetitively recorded revision numbers is damaged, the other revision numbers are usable, thereby increasing the reliability of the revision number.

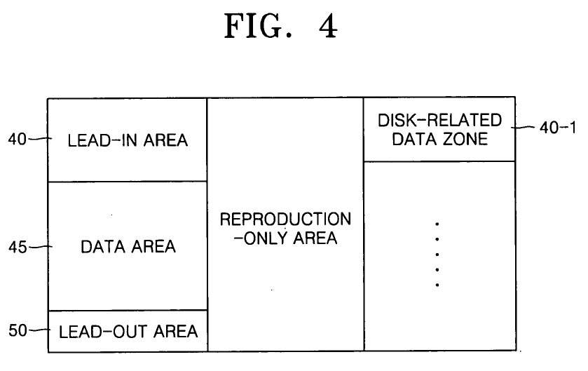

FIG. 4 shows the structure of a data area in a conventional reproduction-only information storage medium, which includes a lead-in area 40, a user data area 45, and a lead-out area 50. All of these areas are comprised of a reproduction-only area. A revision number is recorded particularly in a disk-related data zone 40-1 included in the lead-in area 40. The revision number can be repetitively recorded in both the lead-in and lead-out areas 40 and 50. Alternatively, the revision number is recordable at least twice in the lead-in or lead-out area 40 or 50.

A method of recording and/or reproducing data in an information storage medium according to an embodiment of the present invention will now be described with reference to FIG. 1. First, a standard version number is recorded in the reproduction-only area of at least one of the lead-in and lead-out areas 10 and 30, and a revision number distinguished from the standard version number is also recorded therein. Additional information corresponding to the revision number is separately prescribed in a specified area.

For example, the revision number is recorded in a specified byte of the disk control data zone 10-2 included in the lead-in area 10. If the information storage medium having the revision number is inserted into a drive device, the drive device reads out the standard version number and the revision number and records and/or reproduces data in and/from the information storage medium according to a standard corresponding to the standard version number and the revision number.

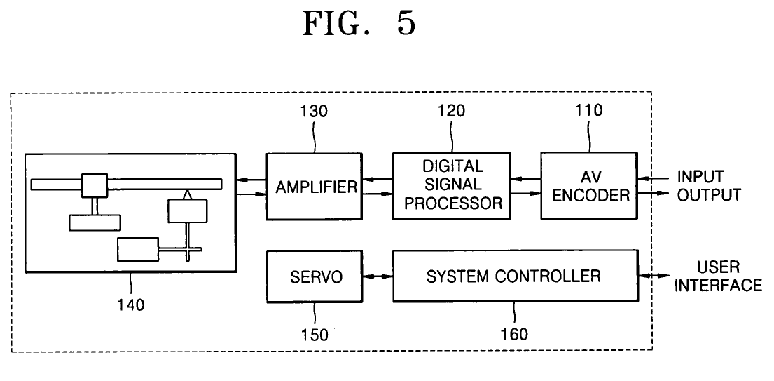

A drive system for recording and/or reproducing data on an information storage medium according to an embodiment of the present invention is shown in FIG. 5. Upon data recording, an audio/video (AV) encoder 110 compresses an AV signal according to a specified compression scheme and provides information about the size of compression data. A digital signal processor 120 receives compressed AV data from the AV encoder 110, adds data for ECC processing to the compressed AV data, and modulates the resulting data according to a specified modulation scheme. A radio frequency (RF) amplifier 130 converts data modulated by the digital signal processor 120 into an RF signal. A pickup 140 records the RF signal received from the RF amplifier 130 on a disk mounted on a turntable of the pickup 140. A servo 150 receives data necessary for servo control from a system controller 160 and performs a servo function for the disk.

Upon reproduction of data recorded in the disk, the pickup detects an optical signal from the disk and extracts the recorded data from the optical signal. The RF amplifier 130 converts the optical signal into an RF signal and extracts and modulates a servo signal to perform a servo function. The digital signal processor 120 demodulates the modulated data, which is received from the RF amplifier 130, according to a modulation scheme used for the data modulation, corrects for an error through an error correction code ECC process, and removes the additional data from the recorded data. The servo 150 receives data necessary for servo control from the system controller 160. The AV encoder 110 decodes the compressed AV data received from the digital signal processor 120 and outputs an AV signal. The system controller 160 controls the entire drive system to record or reproduce data on the disk mounted on the turntable of the pickup.

When a storage medium has been inserted into such a drive device, the drive device reads out the version number and the revision number and records and/or reproduces data according to a standard corresponding to the version number and the revision number.

In the data recording and/or reproducing method according to an embodiment of the present invention, if the content of an item in an identical standard version is changed, a revision number corresponding to the changed content is recorded. If the mass eccentricity of a storage medium is changed, a revision number associated with the changed mass eccentricity, for example, number 2.0, is recorded in a specified byte of the disk control data zone 10-2.

Although the case where the mass eccentricity has been changed was described in the above, it is to be understood that the same rule is applicable to the case where a recording speed is changed, so this case is not described in detail.

In the data recording and/or reproducing method according to an embodiment of the present invention, as storage media are quickly upgraded, there is a large possibility that contents determined in standards are modified. Extra data is provided so that the drive recognizes the modified contents.

As described above, in a method of recording and/or reproducing data in an information storage medium according to an embodiment of the present invention, a revision number distinguished from a standard version number is recorded. If an item is changed while the standard for an information storage medium is maintained, a revision number corresponding to the changed content is provided. A drive device, which records and/or reproduces data in a storage medium, recognizes changed information using the revision number and can adaptively record or reproduce data depending on the changed information.

Although a few embodiments of the present invention have been shown and described, the present invention is not limited to the described embodiments. Instead, it would be appreciated by those skilled in the art that changes may be made in these embodiments without departing from the principles and spirit of the invention, the scope of which is defined by the claims and their equivalents.

What is claimed is:

1. An information storage medium comprising a reproduction-only area in which a standard version number and a revision number different from the standard version number are recorded.

2. The information storage medium of claim 1, further comprising:
a lead-in area;
a user data area; and
a lead-out area,
wherein the reproduction-only area is included in at least one of the lead-in and lead-out areas.

3. The information storage medium of claim 2, wherein the reproduction-only area is a disk control data zone included in at least one of the lead-in and lead-out areas.

4. The information storage medium of claim 3, wherein the revision number is recorded in an m-th byte of the disk control data zone.

5. The information storage medium of claim 4, wherein each time the revision number is changed, the changed revision number is recorded in the m-th byte.

6. The information storage medium of claim 2, wherein the revision number is repeatedly recorded in both the lead-in and lead-out areas.

7. The information storage medium of claim 4, wherein, when the revision number is x.y, x is recorded in the first four bits of the m-th byte, and y is recorded in the last four bits of the m-th byte.

8. The information storage medium of claim 7, wherein one of a hexadecimal system and a binary system is used to record the revision number.

9. The information storage medium of claim 1, wherein the revision number is repeatedly recorded in at least two of the bytes in the reproduction-only area.

10. The information storage medium of claim 1, wherein the standard version number and the revised number indicate at least one factor associated with data recording and/or reproduction set according to a standard corresponding to the standard version number, and wherein, when the content of at least one of the items changes, the revision number corresponding to the changed item is recorded.

11. The information storage medium of claim 10, wherein the at least one factor is one of a recording speed, a mass eccentricity, and a recording capacity.

12. A method of recording and/or reproducing data in an information storage medium which includes a lead-in area, a user data area, and a lead-out area, the method comprising:
recording a standard version number in the reproduction-only area of at least one of the lead-in and lead-out areas;
recording a revision number distinguished from the standard version number in the reproduction-only area; and
reading the standard version number and the revision number and recording and/or reproducing data according to a standard associated with the standard version number and the revision number.

13. The method of claim 12, wherein a drive performs the reading.

14. The method of claim 12, wherein the reproduction-only area is a disk control data zone included in at least one of the lead-in and lead-out areas.

15. The method of claim 12, wherein the revision number is recorded in an m-th byte of the disk control data zone.

16. The method of claim 15, wherein every time the revision number is changed, the changed revision number is recorded in the m-th byte.

17. The method of claim 12, wherein the revision number is repeatedly recorded in both the lead-in and lead-out areas.

18. The method of claim 15, wherein, when the revision number is x.y, x is recorded in the first four bits of the m-th byte, and y is recorded in the last four bits of the m-th byte.

19. The method of claim 12, wherein the revision number is repeatedly recorded in at least two of the bytes in the reproduction-only area.

20. A drive system for recording and/or reproducing data on an information storage medium having a reproduction-only area in which a standard version number and a revision number different from the standard version number are recorded, comprising:
a pickup which records and/or reproduces the data from the information storage medium,
wherein, when the information storage medium is inserted into the drive system, the drive system reads out the version number and the revision number and records and/or reproduces the data according to a standard corresponding to the version number and the revision number.

21. A drive system for recording data on an information storage medium, comprising:
an audio/video (AV) encoder which compresses an AV signal according to a specified compression scheme and outputs compressed AV data;
a digital signal processor which receives the compressed AV data, adds data for electronic code correction (ECC) processing to the compressed AV data, modulates the resulting data according to a specified modulation scheme, and outputs modulated data;
a radio frequency (RF) amplifier which converts the modulated data into an RF signal; and
a pickup which records the RF signal on the information storage medium,
wherein the data includes a standard version number and a revision number different from the standard version number.

22. A drive system for reproducing data recorded on an information storage medium, comprising;
a pickup which detects an optical signal from the information storage medium;
a radio frequency (RF) amplifier which converts the optical signal into an RF signal of modulated data and outputs the RF signal;
a digital signal processor which demodulates the modulated data according to a modulation scheme, performs error correction code (ECC) processing, and outputs compressed audio/video (AV); and
an AV decoder which decodes the compressed AV data and outputs an AV signal,
wherein the data is a standard version number and a revision number different from the standard version number.
